(19) United States
(12) Patent Application Publication
(10) Pub. No.: US 2004/0185819 A1
(43) Pub. Date: Sep. 23, 2004

(54) Compensating for differences in signal paths in an electronic module

(75) Inventors: Kimmo Kyllonen, Shakopee, MN (US); Udara Fernando, Eagan, MN (US)

Correspondence Address: FOGG AND ASSOCIATES, LLC, P.O. BOX 581339, MINNEAPOLIS, MN, 55458-1339, US

(73) Assignee: ADC Telecommunications, Inc.

(21) Appl. No.: 10/393,208

(22) Filed: Mar. 19, 2003

(51) Int. Cl. H04B 1/16

(52) U.S. Cl. 455/341; 455/334

(57) ABSTRACT

An electronic circuit is provided. The electronic circuit includes a first port, a second port, a first path coupled between the first and second ports, and a second, alternative path coupled between the first and second ports. The electronic circuit also includes at least one tunable circuit element shared between the first and second, alternative paths. The first path includes a delay line with a length selected to match at least one characteristic of the first path with a corresponding characteristic of the second path within a selected tolerance.

### TECHNICAL FIELD

The present invention relates generally to the field of electronic circuits and, in particular, to compensating for differences in signal paths in an electronic module.

### BACKGROUND

Wireless telecommunications systems transmit signals between users using radio frequency (RF) signals. A typical wireless system includes a plurality of base stations that are connected to the public switched telephone network (PSTN) via a mobile switching center (MSC). Each base station includes a number of radio transceivers that are typically associated with a transmission tower. Each base station is located so as to cover a geographic region known colloquially as a “cell.” Each base station communicates with wireless terminals, e.g. cellular telephones, pagers, wireless modems, and other wireless terminals, located in its geographic region or cell.

A base station includes a number of modules that work together to process RF signals. These modules typically include, by way of example, mixers, amplifiers, filters, transmission lines, antennas and other appropriate circuits. One type of filter that finds increased use in wireless base stations is known as a cavity filter.

Cavity filters typically include a plurality of resonators located in a housing. The frequency response of each resonator is adjusted using a tuning member, e.g., a tuning screw, which extends through a plate of the housing into the cavity of the resonator. A group of resonators coupled in series form a filter. The filter has a frequency response determined by the frequency response of the resonators. The filter's frequency response determines the range of frequencies that are passed/blocked by the filter.

In a typical base station, an amplifier module is mounted at the top of the base station tower. This amplifier module is provided to amplify RF signals received at the antenna from wireless terminals. A typical amplifier module includes two signal paths between ports to pass signals from an antenna to a base station transceiver. The main signal path includes an amplifier circuit and the secondary signal path bypasses the amplifier circuit. The secondary signal path assures that some RF signal is passed through the amplifier module to the base station in the event of a failure of the amplifier circuit, e.g., loss of power or other failure.

Typically, the RF signals are filtered before and after application to the amplifier circuit within the amplifier module. In normal or amplifier mode of operation, the RF signals are received at the antenna and provided to the amplifier module. The RF signals are filtered to select the appropriate frequency band used by the service provider associated with the base station. The filtered signals are amplified by the amplifier circuit and then filtered again to make sure the proper signals are provided to the base station. In the event of failure of the amplifier, the bypass mode provides a direct signal path between the filters so that RF signals can be provided to the base station even if the amplifier circuit is not operational, e.g., the amplifier circuit fails or loses power.

During manufacturing of the amplifier module, the filters are tuned to meet specified frequency response requirements. For example, the tuning screws are adjusted to allow signals of a selected range or pass band to be provided to the amplifier circuit. A technician selectively adjusts the position of the tuning members in the plate for each resonator of the filter in an iterative process until the correct frequency response is achieved. This can be a tedious and time-consuming process.

For proper operation of the amplifier module, the input and output impedance of the amplifier module must also meet specific requirements. For example, an amplifier module typically requires input and output impedance to be 50 Ohms. For a 50 Ohm impedance, the input and output return losses must both be less than −20 dB. The tuning process for the filters described above also affects the input and output impedance of the filters. Change in input output impedance of the filter will result a change in input output impedance of the amplifier module. These conditions must be met in both amplifier mode and bypass mode of operation, e.g., for both signal paths.

It is difficult to meet the return loss requirements in both modes due to impedance mismatch between the filters and the amplifier and between the filters and the bypass signal path. Even if both filters and the amplifier have acceptable return loss values, the complete assembly may not meet the overall requirement across the received frequency band. Further, even if the appropriate return loss levels are reached for the amplifier mode, the return loss levels will not automatically be acceptable in the bypass mode. Thus, conventional approaches to tuning an amplifier module involve an iterative process of tuning in one mode and then the other until acceptable return loss levels are achieved in both modes. Unfortunately, this iterative approach can introduce significant delay into the manufacturing process even for a skilled artisan. Further, to achieve acceptable return loss levels, current approaches may sacrifice performance levels by setting the return loss level well below the −20 dB requirement in one mode to achieve acceptable levels in both modes.

For the reasons stated above, and for other reasons stated below which will become apparent to those skilled in the art upon reading and understanding the present specification, there is a need in the art for compensating for differences between signal paths in an electronic module.

### SUMMARY

The above mentioned problems compensating for differences between signal paths in an electronic module and other problems are addressed by embodiments of the present invention and will be understood by reading and studying the following specification. Embodiments of the present invention provide for meeting operational requirements for two signal paths while tuning an element of an electronic module in only one of the signal paths by adjusting at least one characteristic, e.g., group delay, such that the characteristic for both signal paths are within a specified range of each other.

In one embodiment, an electronic circuit is provided. The electronic circuit includes a first port, a second port, a first path coupled between the first and second ports, and a second, alternative path coupled between the first and second ports. The electronic circuit also includes at least one tunable circuit element shared between the first and second, alternative paths. The first path includes a delay line with a length selected to match at least one characteristic of the first path with a corresponding characteristic of the second path within a selected tolerance.

### BRIEF DESCRIPTION OF THE DRAWINGS

FIG. 1 is a block diagram of one embodiment of an electronic module that compensates for different characteristics of first and second signal paths according to the teachings of the present invention.

FIG. 2 is a graph that illustrates an example of different group delays between first and second paths of an amplifier module without adjustment according to the teachings of the present invention.

FIG. 3 is a graph that expands on a region of the graph of FIG. 2.

FIG. 4 is a graph that illustrates an example of different group delays between first and second paths of an amplifier module with adjustment according to the teachings of the present invention.

FIG. 5A is a top view of one embodiment of a delay line according to the teachings of the present invention.

FIG. 5B is a cross sectional view of one embodiment of a delay line according to the teachings of the present invention.

FIG. 5C is a top view of one embodiment of a delay line after adjusting its length according to the teachings of the present invention.

FIGS. 6a and 6b are graphs that illustrate sample input return loss and output return loss for an amplifier module with a bypass line according to the teachings of the present invention.

FIG. 7 is a block diagram of one embodiment of a base station including an amplifier module according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

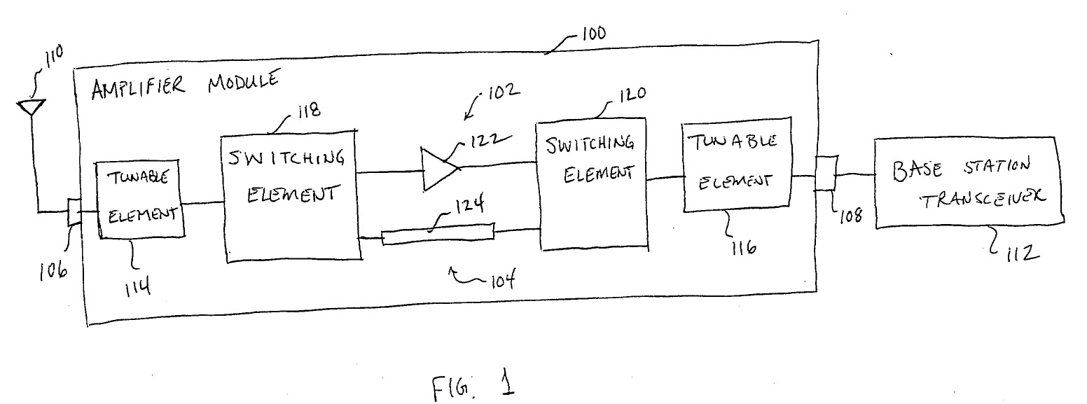

FIG. 1 is a block diagram of an electronic module, indicated generally at 100, that compensates for differences between first and second signal paths 102 and 104 according to the teachings of the present invention. In this embodiment, first signal path 102 includes an amplifier. Therefore, for purposes of this description, electronic module 100 is referred to as “amplifier module” 100. It is understood that in other embodiments, electronic module 100 includes other circuitry with first and second alternative paths.

Amplifier module 100 includes tunable elements, e.g., tunable elements 114 and 116, which are common to the first and second paths 102 and 104. Advantageously, these tunable elements 114 and 116 of amplifier module 100 are more readily tuned during production compared to existing amplifier modules by matching a characteristic of each of first and second paths 102 and 104 during production. During production, a technician tunes the tunable elements 114 and 116 of amplifier module 100 to comply with one or more selected operational requirements or parameters over one of the first and second paths 102 and 104. These operational requirements include but are not limited to gain, input return loss, output return loss, insertion gain/loss, input/output impedance, and any other appropriate operational requirement. Without further tuning, the amplifier module 100 meets the same operational requirement(s) for the other of the first and second paths 102 and 104.

In one embodiment, the electronic module 100 has operational requirements or parameters that include specified levels for input and output impedance that must be met in both the first and second paths 102 and 104. These requirements are complicated by the inclusion of tunable elements 114 and 116 that are common to the first and second paths 102 and 104 because the tunable elements 114 and 116 affect the input/output impedance of the electronic module. Further, there is an impedance mismatch between the tunable elements and other elements of the first and second paths 102 and 104. Thus, if the first and second paths are not compensated, a complicated, iterative approach is often used to assure that the operational requirement is met for both paths. Advantageously, it has been discovered that if a selected characteristic of the first and second paths 102 and 104, e.g., the group delay, is sufficiently similar to within a selected tolerance, then the operational requirement(s) can be met in both paths while only tuning the tunable elements in one path.

Amplifier module 100 includes first port 106 and second port 108. Fist and second paths 102 and 104 pass between first and second ports 106 and 108. First port 106 is coupleable to antenna 110 and second port 108 is coupleable to a base station transceiver (BTS) 112. In this embodiment, first port 106 is also coupled to tunable element 114 and second port 108 is coupled to tunable element 116. In one embodiment, tunable elements 114 and 116 comprise tunable coaxial cavity filters and are thus also referred to herein as tunable filters 114 and 116. In other embodiments, tunable elements 114 and 116 comprise other types of filters such as lumped element filters, printed circuit board filters. Tunable filters 114 and 116 comprise one of band pass, low pass and high pass filters.

Tunable filter 114 is coupled to the input of switching element 118 and tunable filter 116 is coupled to an output of switching element 120. Switching element 118 is also common to both paths. Switching element 118 receives signals from tunable filter 114 and switches the signals to one of first and second paths 102 and 104. Conversely, switching element 120 receives signals from one of first and second paths 102 and 104 and provides the signals to tunable filter 116. In one embodiment, switching elements 118 and 120 comprise relays. In other embodiments, switching elements 118 and 120 comprise active switches such as PIN diodes, PIN diodes with quarter wave lines and transistor switches. Switching elements 118 and 120 are included to direct the flow of signals from one or more inputs to a selected one of one or more outputs.

In the embodiment shown in FIG. 1, amplifier module 100 includes amplifier 122 in first signal path 102. In the alternative, second signal path, amplifier module 100 includes bypass line 124. Bypass line 124 is provided to carry signals from the antenna 110 to the base station 112 in case of failure or loss of power to the amplifier 122.

First and second signal paths 102 and 104 transmit signals between antenna 110 and base station transceiver 112. In amplifier module 100, the signals received at antenna 110 are filtered at tunable filter 114 to select the appropriate frequency band for the service associated with the base station transceiver. Signals in the selected band are passed along one of first and second paths 102 and 104 by switching element 118. First path 102 amplifies the signals, when present, with amplifier 122. In case of malfunction or loss of power to amplifier 122, second path 104 carries the unamplified signals from antenna 110 to base station transceiver 112. Thus, signals are not inhibited from being passed to base station transceiver 112 when there are problems with first path 102.

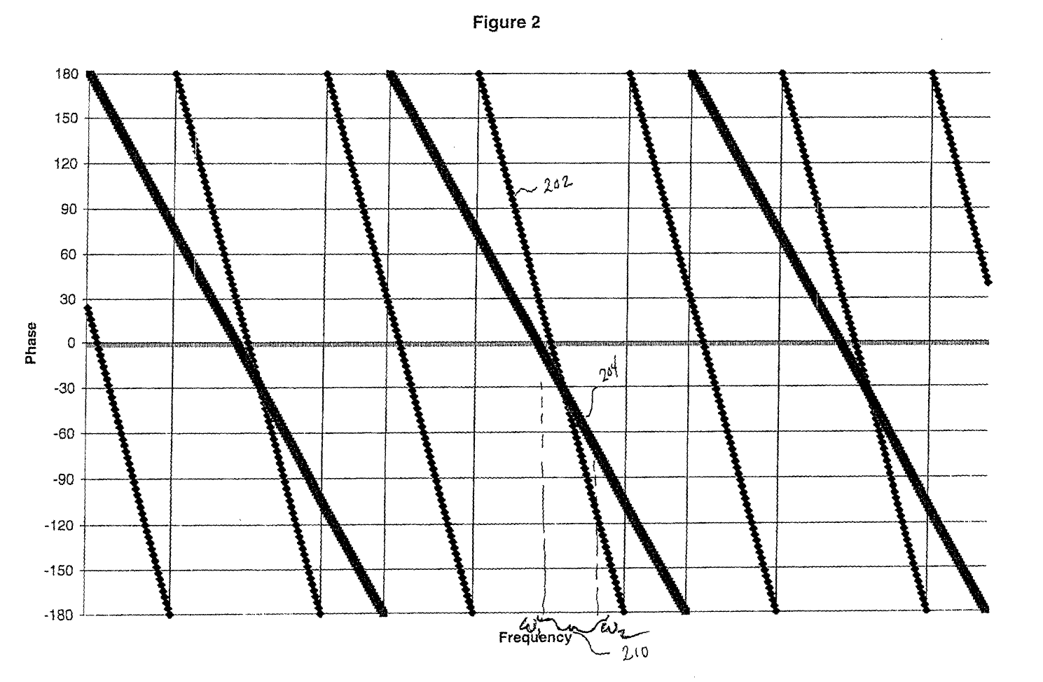

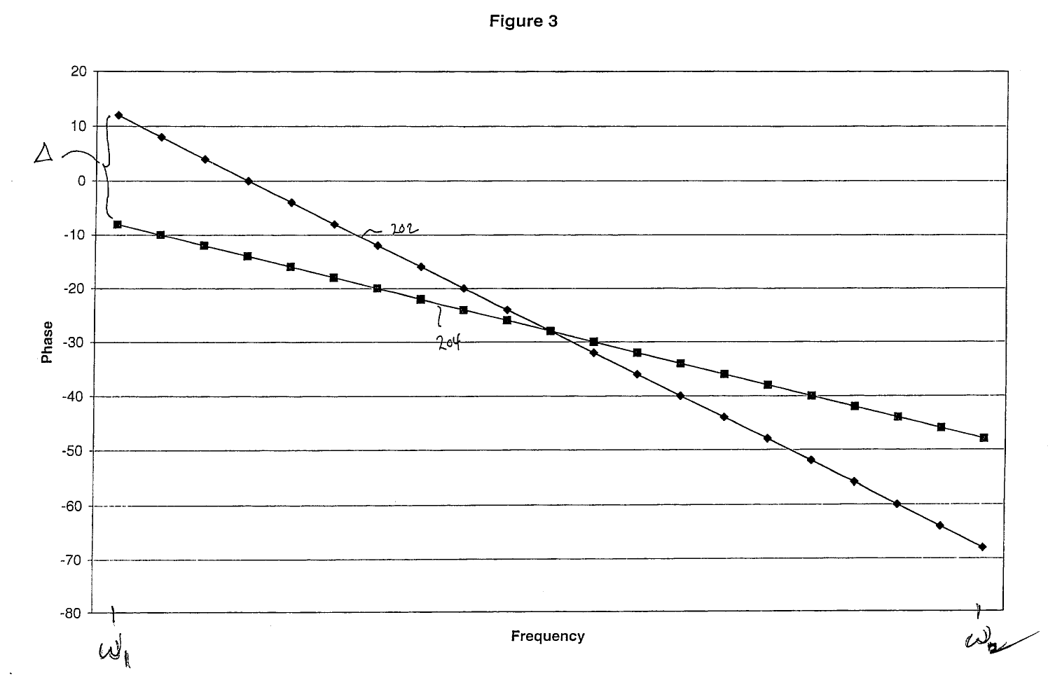

Advantageously, second signal path 104 includes an element that compensates for a selected characteristic of first signal path 102 so as to reduce the time required to tune amplifier module 100 in production. In one embodiment, the selected characteristic is the group delay of the amplifier and the group delay of the delay line. Group delay is the rate of change of the phase angle of a signal with respect to frequency. FIGS. 2 and 3 illustrate the uncompensated group delays of first and second paths 102 and 104. As illustrated, the group delay 202 for first path 102 and the group delay 204 for second path 104 differ by up to 20 degrees over the target bandwidth, 210, as indicated by the reference Δ. It has been determined that if the difference in the group delay is less than about 10 degrees over a specified bandwidth, then the tunable elements can be tuned for both signal paths by tuning the tunable elements in just one of the signal paths.

In one embodiment, second path 104 includes a delay line 124 of length l. The length l of delay line 124 is chosen, in one embodiment, to produce a group delay within an acceptable range of the group delay of the amplifier 122. In one embodiment, this range is within about 10 degrees of the group delay over a specified bandwidth. Group delay for a delay line is calculated according to the following equation:

$$Group Delay = {τ}_{D} = - \frac{ⅆ φ}{ⅆ ω} = l \sqrt{μ ϵ}$$

As shown in equation 1, the length of the delay line controls the group delay for the delay line 124.

Advantageously, amplifiers that are manufactured in the same lot typically have group delays that vary by up to 5 degrees over a typical bandwidth. Thus, during production of amplifier modules, the manufacturer determines an appropriate length for the delay line through experimentation, e.g., with one or a small number of amplifiers, and then the same length is used for all amplifiers in the lot. Due to the range of the group delay among the amplifiers, it is expected that the same length can be used for the delay lines in each amplifier module and still achieve the necessary range of +/−10 degrees in group delay.

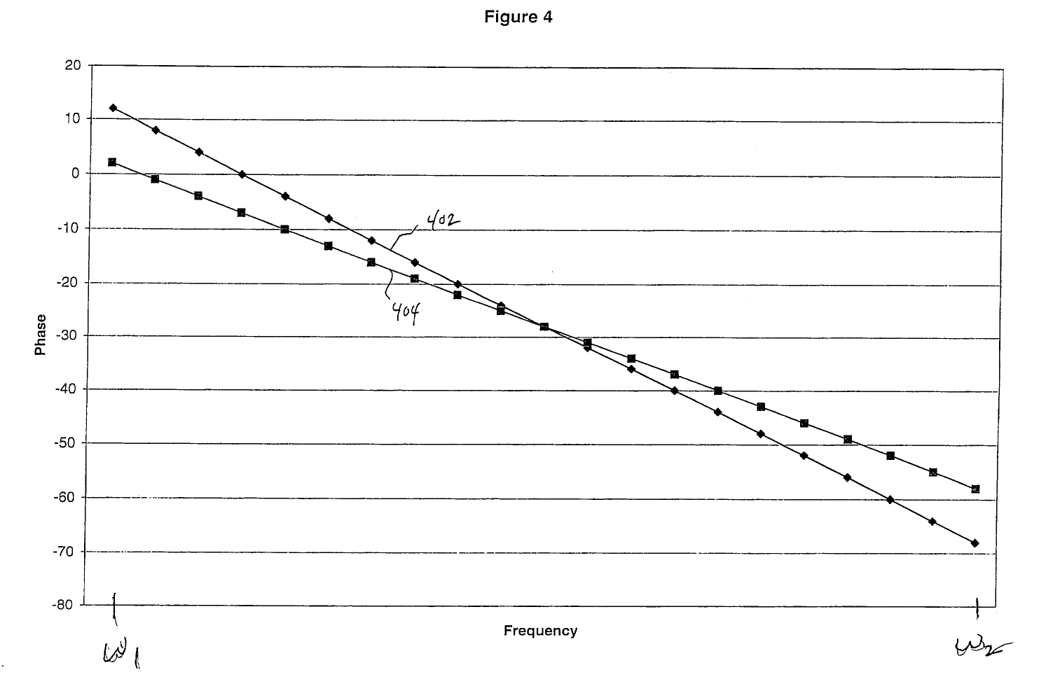

FIG. 4 is a graph that illustrates an example of the adjusted group delays when the length of delay line 124 is selected appropriately. In this example, FIG. 4 illustrates that the group delay 402 of amplifier 122 is no more than 10 degrees different from the group delay 404 of delay line 124 over the frequency range of interest.

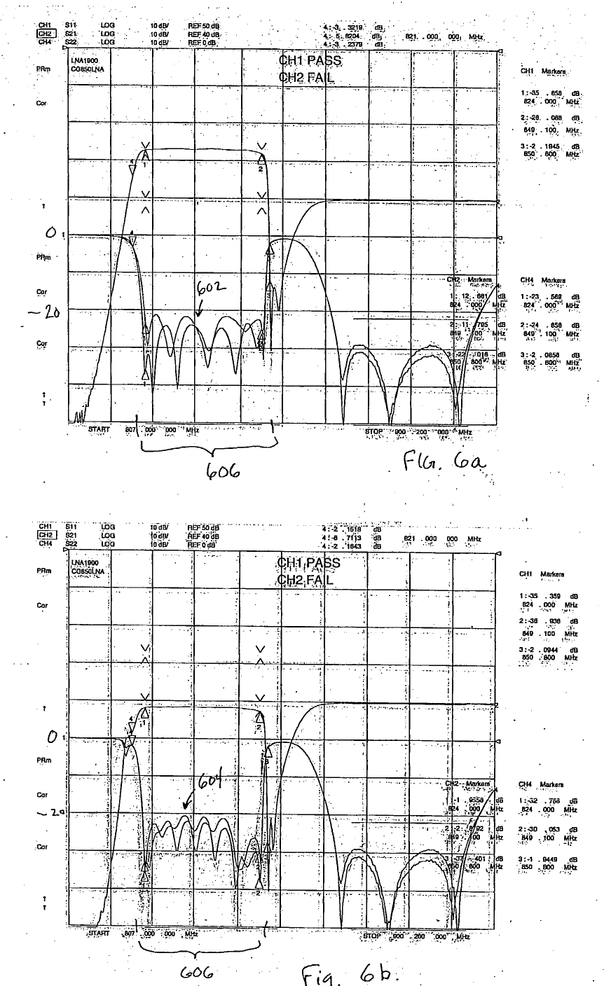

With the group delays within this acceptable range, the tuning elements 114 and 116 are tuned to achieve selected criteria over one of the signal paths 102 and 104. In one embodiment, the filters 114 and 116 are tuned to achieve input and output return losses for both amplifier and bypass modes that are less than −20 dB. In one embodiment, this tuning is accomplished by adjusting the positioning of tuning screws in the housing of the cavity filter. FIGS. 6a and 6b illustrate a sample input return loss and output return loss for an amplifier module with a bypass line according to the teachings of the present invention. As shown, the input and output return loss indicated at 602 in the amplifier mode and the input and output return loss 604 in the bypass mode are less than −20 dB over the frequency range 606. In one embodiment, once the filters are tuned over one of the first and second paths, the other path is tested to determine that the operational requirements also are met for that path.

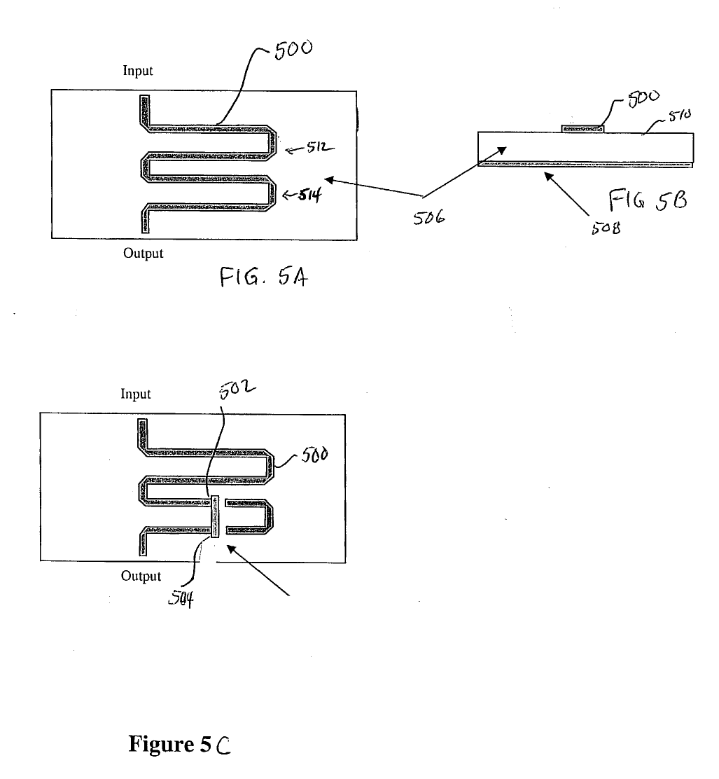

FIGS. 5A, 5B, and 5C illustrate one embodiment of a delay line, indicated generally at 500, according to teachings of the present invention. Delay line 500 is a serpentine delay line formed on surface 510 of circuit board material 506. Ground plan 508 is formed on a side opposite surface 510 of circuit board 506. Delay line 500 includes sections 512 and 514 that fold back upon themselves to allow selective modification of the length of the delay line during production. Delay line 500 is not limited to two serpentine sections 512 and 514. In other embodiments, delay line 500 includes any appropriate number of serpentine sections. Further, the serpentine sections in other embodiments are not limited to U-shaped traces. Traces of other shapes are also acceptable.

As illustrated in FIG. 5C, the length of delay line 500 is controlled by selectively soldering a connection between points, e.g., points 502 and 504, cut in the delay line 500. In production, an amplifier module is configured with a sample amplifier from a lot. The length of the delay line 500 is adjusted by cutting the delay line at a point in one of sections 512 and 514 until the group delay achieves an acceptable match. Once this length is determined, the same length of the delay line is used in configuring the remaining amplifier modules.

In other embodiments, the group delay of one amplifier is measured and then an appropriate length for the delay line is calculated.

In one embodiment, the length of the delay line is chosen as follows. First, tunable elements 114 and 116 are tuned with amplifier 122 power on or choosing path 102 until input 106 and output 108 of the amplifier module 100 has return loss bellow −20 dB. Next, amplifier module 100 is switched to delay line 124 or path 104. In this mode, the length of the delay line 500 is adjusted until input 106 and output 108 of the amplifier module 100 have return loss bellow −20dB. After these two steps, amplifier module 100 will have 50 ohm impedance regardless of which signal path is chosen internally.

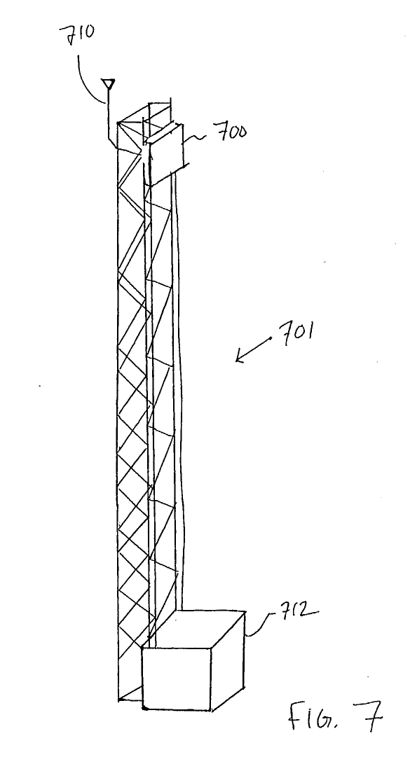

FIG. 7 is a block diagram of one embodiment of a base station, indicated generally at 701, including an amplifier module 700 according to the teachings of the present invention. Amplifier module 700 includes first and second signal paths that are compensated to have group delays within an acceptable range. Amplifier module 700 is coupled to antenna 710 and to base station transceiver 712. In one embodiment, amplifier module 700 is constructed as described above with respect to any one or more of FIGS. 1, 2, 3, 4, 5A, 5B, 5C, 6a and 6b.

What is claimed is:

1. A method for manufacturing an amplifier module having first and second paths between a first port and a second port, the method comprising:
incorporating a delay line into the first path, the delay line having a length selected such that a group delay of the first path falls within a selected range of a group delay of the second path;
tuning at least one filter of the amplifier module to achieve a selected operating parameter in one of the first and second paths; and
verifying compliance with the selected operating parameter in the other of the first and second paths without further tuning of the at least one filter.

2. The method of claim 1, and further including:
incorporating the at least one filter into the first and second paths; and
incorporating an amplifier circuit in the second path.

3. The method of claim 1, wherein tuning at least one filter comprises tuning at least one cavity filter.

4. The method of claim 1, wherein tuning at least one filter comprises tuning at least one filter to achieve an input/output return loss below −20 dB for the first path.

5. The method of claim 1, wherein incorporating a delay line comprises incorporating a delay line that matches a group delay of the first path to within 10 degrees of a group delay of the second path over a selected frequency range.

6. A method for tuning filters in an amplifier module, the method comprising:
selecting a delay line length for a bypass line to establish a group delay that falls within a selected range of a group delay of an amplifier; and
tuning the filters in the amplifier module while connected over one of the bypass line and the amplifier such that the filters achieve a selected criteria for both the bypass line and a second path including the amplifier.

7. The method of claim 6, wherein tuning the filters comprises tuning the filters to achieve an input/output return loss below −20 dB for the first path.

8. The method of claim 6, wherein selecting a delay line length comprises selecting a delay line length that matches a group delay of the bypass line to within 10 degrees of a group delay of the amplifier over a selected frequency range.

9. The method of claim 6, wherein tuning the filters comprises selectively adjusting a plurality of tuning screws in cavity filters.

10. The method of claim 6, wherein selecting a delay line length comprises using a serpentine layout for the delay line.

11. An amplifier module, comprising:
a first port;
a second port;
a first tunable filter coupled to the first port;
a second tunable filter coupled to the second port;
a first switching element coupled to the first filter;
a second switching element coupled to the second filter;
an amplifier coupled between the first switching element and the second switching element;
a bypass line coupled between the first switching element and the second switching element; and
wherein the length of the bypass line is selected to have a group delay that is substantially matched with the group delay of the amplifier.

12. The amplifier module of claim 11, wherein the bypass line comprises a serpentine bypass line.

13. The amplifier module of claim 11, wherein the first and second switching elements comprise relays.

14. The amplifier module of claim 11, wherein the first port is adapted to be coupled to an antenna and the second port is adapted to be coupled to a base station transceiver.

15. The amplifier module of claim 11, wherein the first and second tunable filters comprise bandpass filters.

16. An amplifier module, comprising:
a first port;
a second port;
a first path coupled between the first and second ports;
a second path coupled between the first and second ports;
wherein the first and second paths share at least one tunable filter; and
wherein a length of a bypass line of the first path is selected such that a group delay of the first path falls within a selected range about a group delay of the second path.

17. The amplifier module of claim 16, wherein the second path includes at least one amplifier.

18. The amplifier module of claim 16, wherein the first port is adapted to be coupled to an antenna and the second port is adapted to be coupled to a base station transceiver.

19. The amplifier module of claim 16, wherein the bypass line comprises a serpentine bypass line.

20. The amplifier module of claim 16, wherein the first and second paths share two cavity filters.

21. An electronic circuit, comprising:
a first port;
a second port;
a first path coupled between the first and second ports;
a second, alternative path coupled between the first and second ports;
at least one tunable circuit element shared between the first and second, alternative paths;
wherein the first path includes a delay line with a length selected to match at least one characteristic of the first path with a corresponding characteristic of the second path within a selected tolerance.

22. The electronic circuit of claim 21, wherein the delay line comprises a serpentine delay line.

23. The electronic module of claim 21, wherein the at least one tunable circuit element comprises a tunable cavity filter.

24. A base station, comprising:
a tower;
an antenna mounted on the tower;
an amplifier module coupled to the antenna;
a base station transceiver unit, coupled to the antenna and including a port for coupling to a network; and
wherein the amplifier module includes:
a first port coupled to the attenna;
a second port coupled to the base station transceiver;
a first path coupled between the first and second ports;
a second path coupled between the first and second ports;
wherein the first and second paths share at least one tunable filter; and
wherein a length of a bypass line of the first path is selected such that a group delay of the first path matches a group delay of the second path to within a selected tolerance.

25. The base station of claim 24, wherein the second path includes at least one amplifier.

26. The base station of claim 24, wherein the first port is adapted to be coupled to an antenna and the second port is adapted to be coupled to a base station transceiver.

27. The base station of claim 24, wherein the bypass line comprises a serpentine bypass line.

28. The base station of claim 24, wherein the first and second paths share two cavity filters.

29. A method for tuning filters in an amplifier module, the method comprising:
selecting a delay line length for a bypass line to match a characteristic of the bypass line with a corresponding characteristic of an amplifier to within a selected tolerance; and
tuning the filters in the amplifier module while connected over one of the bypass line and the amplifier such that the filters achieve a selected criteria for both the bypass line and a second path including the amplifier.

30. An amplifier module, comprising:
an antenna port;
a base station port;
a first tunable cavity filter coupled to the antenna port;
a second tunable cavity filter coupled to the base station port;
a first relay with an input and first and second outputs, the input coupled to the first filter tunable cavity filter;
wherein the first relay selectively couples signals to one of its first and second outputs;
a second relay with first and second inputs and an output, the output coupled to the second tunable cavity filter;
wherein the second relay selectively couples signals from one of its first and second inputs to its output;
a low noise amplifier coupled between the first output of the first relay and the first input of the second relay;
a bypass line coupled between the second output of the first relay and the second input of the second relay; and
wherein the length of the bypass line is selected to have a group delay that is substantially matched with the group delay of the low noise amplifier.

31. An amplifier module, comprising:
a first port;
a second port;
a first path coupled between the first and second ports;
a second, alternative path coupled between the first and second ports;
at least one tunable circuit element shared between the first and second, alternative paths;
wherein the first signal path includes an element that matches at least one characteristic of the first path to a corresponding characteristic of the second path within a selected tolerance.

32. An electronic circuit, comprising:
a first port;
a second port;
a first path coupled between the first and second ports;
a second, alternative path coupled between the first and second ports;
at least one tunable circuit element shared between the first and second, alternative paths;
wherein the first path includes a circuit element that is selected to match at least one characteristic of the first path with a corresponding characteristic of the second path within a selected tolerance.

33. A method for producing a plurality of amplifier modules, each amplifier module having first and second paths, the method comprising:
determining a line length for a delay line of one of the amplifier modules using a first amplifier circuit in a lot of amplifier circuits such that a characteristic of the first path falls within an acceptable range of a characteristic of the second path;
tuning a tunable element associated with the first and second paths over one of the first and second paths; and
assembling and tuning additional amplifier modules using the same delay line length and amplifier circuits from the same lot.

34. A method for tuning filters in an amplifier module, the method comprising:
tuning the filters in the amplifier module while connected over a path including an amplifier such that the filters achieve a selected criteria; and
selecting a delay line length for a bypass line to achieve a selected criteria such that a group delay of the delay line falls within a selected range of a group delay of the path including the amplifier.
